(19) United States
(12) Patent Application Publication
(10) Pub. No.: US 2021/0176650 A1
(43) Pub. Date: Jun. 10, 2021

(54) Methods, Network Function Entities and Computer Readable Media for Data Collection

(71) Applicant: Telefonaktiebolaget LM Ericsson (publ), Stockholm (SE)

(72) Inventors: Cheng Wang, Shanghai (CN); Ping Chen, Shanghai (CN); Xiaojun Yin, Shanghai (CN); Xinyu Zhang, Shanghai (CN)

(21) Appl. No.: 16/768,780

(22) PCT Filed: Dec. 22, 2017
(86) PCT No.: PCT/CN2017/118064

§ 371 Date: Jun. 1, 2020

(51) Int. Cl. H04W 24/04; H04W 8/14

(52) U.S. Cl. CPC H04W 24/04; H04W 8/14

(57) ABSTRACT

The present disclosure provides methods for collecting data in a network comprising a set of NF entities, and corresponding NF entities. The method comprises receiving a data collection request from a requesting NF entity, including at least Cl data collection object indicating data to be, collected from at least a sub-set of the set of NF entities and a data collection policy indicating how the data shall be collected; determining selected data based on the data collection object included in the data collection request; collecting the selected data based on the data collection policy included in the data collection request; and returning the collected data to the requesting NF entity. The present disclosure further discloses a corresponding method which comprises transmitting the data collection request and receiving data in response to the transmission of the data collection request. The present disclosure further provides corresponding computer readable medium.

### TECHNICAL FIELD

The present disclosure generally relates to the technical field of telecommunication, and particularly to methods and Network Function (NF) entities for collecting data in a network comprising a set of NF entities and corresponding computer readable media.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In Fifth Generation (5G) networks, a Network Slice is introduced as a logical network that provides specific network capabilities and network characteristics. An instance of a network slice (e.g. a network slice instance, NSI) is a set of Network Function (NF) instances and the required resources (e.g., compute, storage, and networking resources) which form a deployed Network Slice. A NF is a 3GPP adopted or 3GPP defined processing function in a network, which has defined functional behaviour and 3GPP defined interfaces. An NF can be implemented either as a network element on dedicated hardware, a software instance funning on a dedicated hardware, or as a virtualized functional instantiated on an appropriate platform, e.g., on a cloud infrastructure.

Among the NF, a NRF (Network Function Repository Function) is defined, which functions to collect data from other NFs in the network.

3GPP 5GC also defines a NF, NWDAF (Network Data Analytics Function), to support data analytics in 5GC. As per service definition in TS23.502, the following two services have been defined:
Nnwdaf_Events_Subscription Service: this service enables the consumer to subscribe/unsubscribe for NWDAF slice congestion events notification. Periodic notification and notification upon threshold exceeded can be subscribed.
Nnwdaf_Analytics_Info service: this service enables the consumer to request and get from NWDAF operator specific analytics. These represent operator specific analytics that have a meaning only in its network. Analytic ID identifying the requested Operator specific Analytic with the identification information of the corresponding slice explicitly or implicitly.

It can be seen so far, it is defined only in generic level how an NF consumer may request analytic information about Network slicing from NWDAF.

### SUMMARY

The main driving force to explicitly define data analytics platform in 3GPP 5GC is of course to improve OPEX/CAPEX and find new revenue resource for network operators, by introducing network operation intelligence to improve network resource utilization, customized network capabilities etc. Then smart exposure and data collection of network internal data can bring essential benefit for agile and efficient network data analytics. NWDAF services as above mentioned are used to perform the data analytics and specific use case has been defined to improving Network Slice Selection.

However, with such existing method, it is not considered yet how the raw data collection, inputting for analytic platform e.g. from all NFs within a network, can be done in an efficient way. Especially, when a specific analytic object is to be defined, e.g. improvement for network slicing selection as example, how the network internal data exposure and collection can be done in a smarter and optimized way instead of NWDAF parsing various data objects from all NFs.

Accordingly, at least some objects of the present disclosure are providing technical solutions capable of collecting data in the network in a smarter way and saving effort to introduce massive NWDAF/NF interfaces.

According to one aspect of the present disclosure, a method for collecting data in a network comprising a set of NF entities is provided, comprising receiving a data collection request from a requesting NF entity, including at least a data collection object indicating data to be collected from at least a sub-set of the set of NF entities and a data collection policy indicating how the data shall be collected; determining selected data based on the data collection object included in the data collection request; collecting the selected data based on the data collection policy included in the data collection request; and returning the collected data to the requesting NF entity.

In an exemplary embodiment, collecting the selected data comprises collecting data from those previously obtained from the sub-set of NF entities.

In an exemplary embodiment, collecting the selected data comprises: determining, according to the data collection policy, whether it needs to obtain data from at least one NF entity of the sub-set of the set of NF entities; and obtain data from the at least one NF entity of the sub-set of the set of NF entities in response to determining that it needs to obtain updated data from the at least one NF entity.

In an exemplary embodiment, determining selected data based on the data collection object included in the data collection request comprises: parsing the data collection object to determine a data object to be collected that is directly obtainable from the selected data.

In an exemplary embodiment, the data collection request comprises at least one data collection object and a least one data collection policy that corresponds to respective one of the at least one data collection object.

In an exemplary embodiment, the data collection request further includes a return policy indicating how the data shall be returned.

In an exemplary embodiment, the method further comprises, prior to returning: determining a form in which the data shall be returned according to the return policy; and processing the collected data to generate data in the determined form.

In an exemplary embodiment, returning the collected data to the requesting NF comprises: returning the collected data to the requesting NF entity at a timing defined according to the return policy.

In an exemplary embodiment, the data collection object comprises at least one of a level of data collection; or a data object to be collected.

In an exemplary embodiment, the data collection policy comprises at least one of a type to which the data shall be collected belongs; or a temporal characteristics of data to be collected.

In an exemplary embodiment, the return policy comprises at least one of a form in which the data shall be returned or a timing at which the data shall be returned.

In an exemplary embodiment, the requesting NF entity comprises at least one of a Network Function Repository Function (NRF) entity, a Network Data Analytics Function (NWDAF) entity, a Network Exposure Function (NEF) entity, a Network Slice Selection Function (NSSF) entity, an Operation and Maintenance (O&M) entity, or a Policy Control Function (PCF) entity.

According to another aspect of the present disclosure, a method for collecting data in a network comprising a set of NF entities is provided, comprising: transmitting a data collection request destined for a requested NF entity, including at least a data collection object indicating data to be collected from at least a sub-set of the set of NF entities and a data collection policy indicating how the data shall be collected; and receiving data from the requested NF entity in response to the transmission of the data collection request.

In an exemplary embodiment, the method further comprises: determining an analytics object; and generating the data collection object and the data collection policy based on the analytics object.

In an exemplary embodiment, the analytics object is triggered locally or received from an external NF entity.

In an exemplary embodiment, the method further comprises: determining an NF entity to which the data collection request is transmitted according to the analytics object; and transmitting the data collection request to the determined NF entity.

In an exemplary embodiment, the data collection request further includes a return policy indicating how the data shall be returned.

According to another aspect of the present disclosure, an NF entity is provided, comprising: a communication interface arranged for communication, at least one processor, and a memory comprising instructions which, when executed by the at least one processor, cause the NF entity to: receive a data collection request from a requesting NF entity, including at least a data collection object indicating data to be collected from at least a sub-set of a set of NF entities and a data collection policy indicating how the data shall be collected; determine selected data based on the data collection object included in the data collection request; collect the selected data based on the data collection policy included in the data collection request; and return the collected data to the requesting NF entity.

According to another aspect of the present disclosure, an NF entity is provided, comprising: a communication interface arranged for communication, at least one processor, and a memory comprising instructions which, when executed by the at least one processor, cause the NF entity to: transmit a data collection request destined for a requested NF entity, including at least a data collection object indicating data to be collected from at least a sub-set of a set of NF entities and a data collection policy indicating how the data shall be collected; and receive data from the requested NF entity in response to the transmission of the data collection request.

According to another aspect of the present disclosure, a computer readable medium which stores computer program comprising instructions which, when executed on at least one processor, cause the at least one processor to perform the methods for data collection as discussed previously.

According to the above technical solutions of the present disclosure, a NF entity which needs to collect data from other NF entities in the network, may generate a data collection request including at least a data collection object and a data collection policy and transmit the generated request to another NF entity in the network which has the data to be collected or passes the data collection request to still another NF entity that has the data to be collected. The NF entity that has the data then collects data and returns the collected data to the requesting NF entity. Thereby, a flexible data collection may be performed in a smarter way and there is no need to introduce massive NWDAF/NF interfaces.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustrates one example of a wireless communication system in which embodiments of the present disclosure may be implemented;

FIG. 2 illustrates a wireless communication system represented as a 5G network architecture composed of core NFs;

FIG. 3 illustrates a 5G network architecture using service-based interfaces between the NFs in the control plane, instead of the point-to-point reference points/interfaces used in the 5G network architecture of FIG. 2;

FIG. 4 illustratively shows a flowchart of a method for collecting data in a network comprising a set of NF entities according to an exemplary embodiment of the present disclosure;

FIG. 5 illustratively shows a flowchart of a method for collecting data in a network comprising a set of NF entities according to an exemplary embodiment of the present disclosure;

FIG. 6 shows an exemplifying signaling diagram illustrating details of the methods schematically illustrated in FIGS. 4 and 5;

FIG. 7 illustratively shows a schematic structure diagram of an NF entity according to an exemplary embodiment of the present disclosure;

FIG. 8 illustratively shows a schematic structure diagram of an NF entity according to an exemplary embodiment of the present disclosure;

FIG. 9 illustratively shows a schematic structure diagram of an NF entity according to an exemplary embodiment of the present disclosure; and

FIG. 10 illustratively shows a schematic structure diagram of an NF entity according to an exemplary embodiment of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP 23.501 (2.0.1),
2) 3GPP 23.502 (2.0.0), and
3) 3GPP 29.891 (2.0.0).

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier-Frequency Division Multiple Access (SC-FDMA), Long Term Evolution (LTE) and other networks developed in the future. The terms “network” and “system” are often used interchangeably. For illustration only, certain aspects of the techniques are described below for the next, i.e. the 5^{th} generation of wireless communication network. However, it will be appreciated by the skilled in the art that the techniques described herein may also be used for other wireless networks such as LTE and corresponding radio technologies mentioned herein as well as wireless networks and radio technologies proposed in the future.

As used herein, the term “UE” may be, by way of example and not limitation, a User Equipment (UE), a SS (Subscriber Station), a Portable Subscriber Station (PSS), a Mobile Station (MS), a Mobile Terminal (MT) or an Access Terminal (AT). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. In the following description, the terms “UE”, “terminal device”, “mobile terminal” and “user equipment” may be used interchangeably.

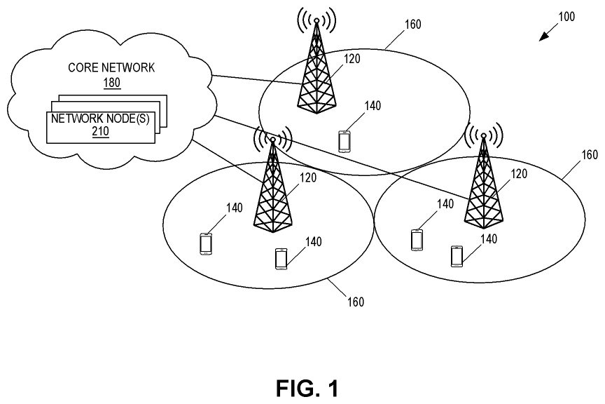

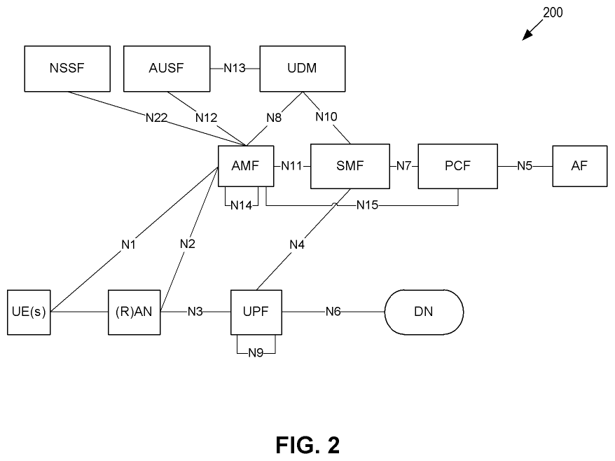

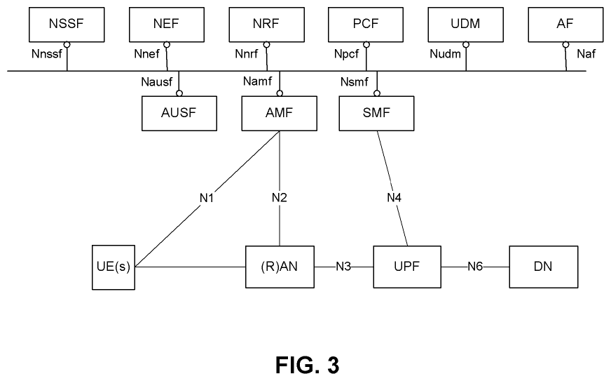

FIG. 1 illustrates one example of a wireless communication system 100 in which embodiments of the present disclosure may be implemented. The wireless communication system 100 may be a cellular communications system such as, for example, a 5G New Radio (NR) network or an LTE cellular communications system. As illustrated, in this example, the wireless communication system 100 includes a plurality of radio access nodes 120 (e.g., evolved Node B:s (eNBs), 5G base stations which are referred to as gNBs, or other base stations or similar) and a plurality of wireless communication devices 140 (e.g., conventional UEs, Machine Type Communication (MTC)/Machine-to-Machine (M2M) UEs). The wireless communication system 100 is organized into cells 160, which are connected to a core network 180 via the corresponding radio access nodes 120. The radio access nodes 120 are capable of communicating with the wireless communication devices 140 (also referred to herein as wireless communication device 140 or UEs 140) along with any additional elements suitable to support communication between wireless communication devices or between a wireless communication device and another communication device (such as a landline telephone). The core network 180 includes one or more network node(s) or function(s) 210. In some embodiments, the network nodes/functions 210 may comprise, for example, any of the network functions shown in FIGS. 2-3.

FIG. 2 illustrates a wireless communication system 200 represented as a 5G network architecture composed of core NFs, where interaction between any two NFs is represented by a point-to-point reference point/interface.

Seen from the access side the 5G network architecture shown in FIG. 2 comprises a plurality of User Equipment (UEs) connected to either a Radio Access Network (RAN) or an Access Network (AN) as well as an Access and Mobility Management Function (AMF). Typically, the R(AN) comprises base stations, e.g. such as evolved Node Bs (eNBs) or 5G base stations (gNBs) or similar. Seen from the core network side, the 5G core NFs shown in FIG. 2 include a Network Slice Selection Function (NSSF), an Authentication Server Function (AUSF), a Unified Data Management (UDM), an Access and Mobility Management Function (AMF), a Session Management Function (SMF), a Policy Control Function (PCF), an Application Function (AF).

Reference point representations of the 5G network architecture are used to develop detailed call flows in the normative standardization. The N1 reference point is defined to carry signaling between UE and AMF. The reference points for connecting between AN and AMF and between AN and UPF are defined as N2 and N3, respectively. There is a reference point, N11, between AMF and SMF, which implies that SMF is at least partly controlled by AMF. N4 is used by SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since PCF applies policy to AMF and SMP, respectively. N12 is required for the AMF to perform authentication of the UE. N8 and N10 are defined because the subscription data of UE is required for AMF and SMF.

The 5G core network aims at separating user plane and control plane. The user plane carries user traffic while the control plane carries signaling in the network. In FIG. 2, the UPF is in the user plane and all other NFs, i.e., AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF and Nsmf for the service based interface of the SMF etc. The Network Exposure Function (NEF) and the Network Function Repository Function (NRF) in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2-3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates IP addresses to UEs. It also selects and controls the UPF for data transfer. If a UE has multiple sessions, different SMFs may be allocated to each session to manage them individually and possibly provide different functionalities per session. The AF provides information on the packet flow to PCF responsible for policy control in order to support Quality of Service (QoS). Based on the information, PCF determines policies about mobility and session management to make AMF and SMF operate properly. The AUSF supports authentication function for UEs or similar and thus stores data for authentication of UEs or similar while UDM stores subscription data of UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

The NRF shown in FIGS. 2-3 is an example of a Repository Function (RF) that is configured to operatively support service discovery functions etc. In particular, the NRF (or similar RF) is configured to operatively maintain relevant information of NF instances served by the NRF, which is called NF profile. The typical NF profile would be, as per TS 23.501:
NF instance ID
NF type
PLMN ID (i.e. Public Land Mobile Network ID)
Network Slice related Identifier(s) e.g. S-NSSAI, NSI ID
FQDN or IP address of NF
NF capacity information
Names of supported services
Endpoint information of instance(s) of each supported service
Other service parameter, e.g., DNN, notification endpoint for each type of notification that the NF service is interested in receiving
etc.

Meanwhile, as per 3GPP spec 29.8911, it specifies more detail of NF profiles as:
the NF instance identifier;
the NF Set identifier (for AMFs);
the NF type (e.g. SMF);
the PLMN ID and the network slice instance(s) to which the NF instance pertains;
the NF services it supports;
NF service authorization information to control whether a requester NF is permitted to discover the NF; the information includes:
   the type(s) and PLMN ID of the NFs allowed to discover the NF instance during the NF service discovery procedure;
   the network slice(s) of the NFs allowed to discover the NF instance during the NF service discovery procedure.
NF service specific information, per supported NF service, including:
   NF service name;
   NF service version;
   protocols and address information (e.g. URI, IP address or FQDN) for use by other NF to access the NF service; a NF service in a NF instance may be accessible via different protocols and address information. Different services of a same NF instance may be accessible via different address information;
   NF service authorization information to control whether a requester NF is permitted to access the NF service; the information includes:
      the type(s) and PLMN ID of the NFs allowed to access the NF for consuming the NF service;
      the network slice(s) of the NFs allowed to access the NF for consuming the NF service;
the PLMN ID and the network slice instance(s) to which the NF instance pertains;
the static capacity of the NF instance at the NF or NF service level (relative to other NF instances of the same type);
the supported DNNs, for SMF instances;
the location of the NF (e.g. list of TAIs the NF instance can serve);
Load information at the NF and NF service level;
etc.

In the context of Network Slicing, based on network implementation, multiple NRFs can be deployed at different levels:
Public Land Mobile Network (PLMN) level (the NRF is configured with information for the whole PLMN),
shared-slice level (the NRF is configured with information belonging to a set of Network Slices),
slice-specific level (the NRF is configured with information belonging to an S-NSSAI).

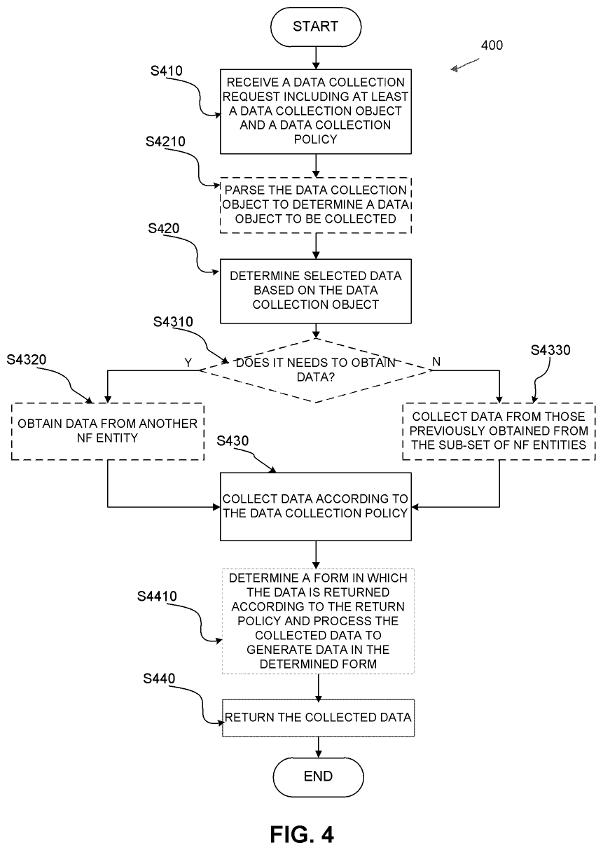

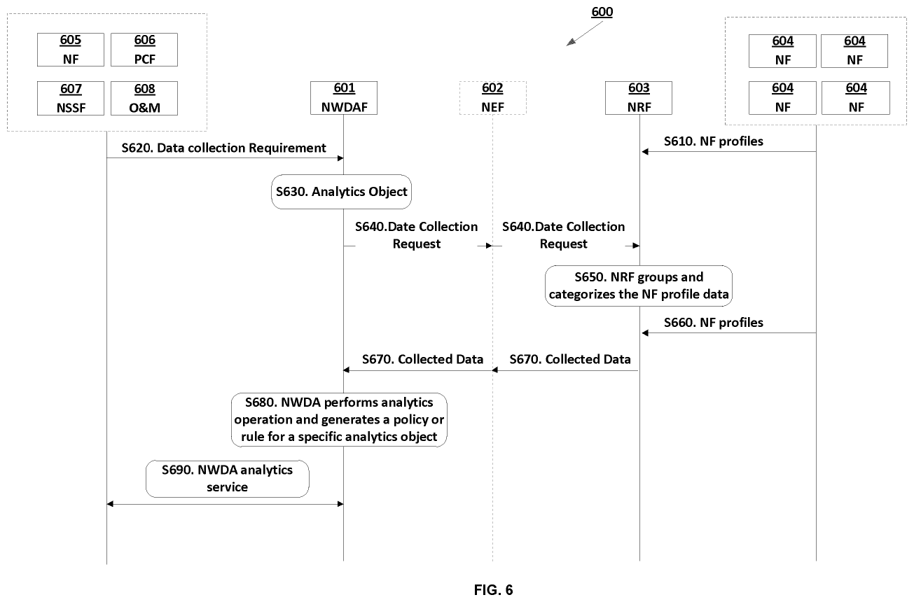

When deploying an NF instance, the management system (e.g. the O&M system) or similar of the network provides the information of the NF instance (e.g. NF type etc.) to the NRF. When the information of the NF instance is changed by the management system or similar entity, it provides the changed information to the NRF serving the NF. When the NF instance is removed, the management system or similar entity deletes the corresponding information of the NF instance in the NRF. However, the particularly NRF shown in FIG. 6 is further configured according to embodiments of the present solution to operatively determine data to be collected from other NF entities when receiving a data collection request, collect the determined data and then return the collected to a requesting NF, as will be further described below with reference to FIGS. 4-6.

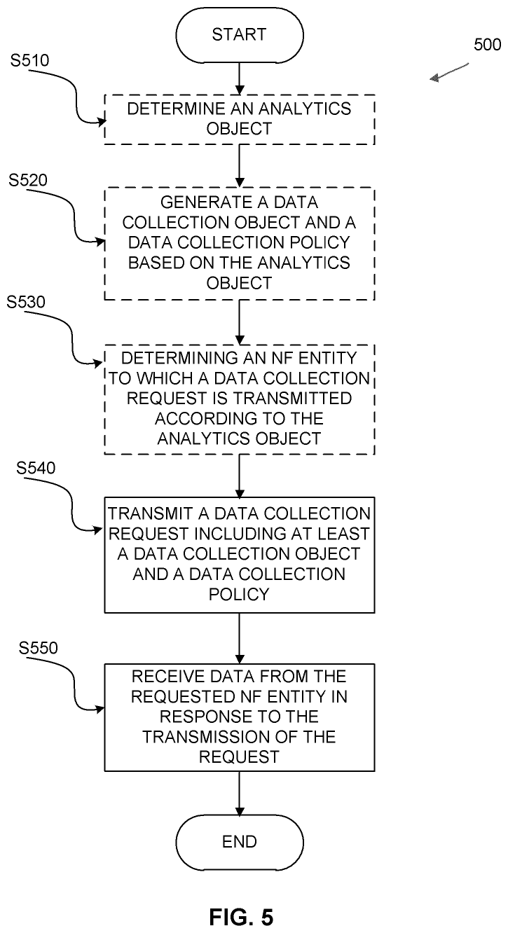

Hereinafter, a method for collecting data in a network comprising a set of NF entities according to an exemplary embodiment of the present disclosure will be described with reference to FIGS. 4 and 5.

FIG. 4 illustratively shows a flowchart of a method 400 for collecting data in a network comprising a set of NF entities according to an exemplary embodiment of the present disclosure. In an embodiment, the method 400 may be performed at a Network Function Repository Function (NRF) entity.

As shown in FIG. 4, the method 400 may include Steps S410˜S440.

In Step S410, a data collection request is received from a requesting NF entity. The data collection request includes at least a data collection object indicating data to be collected from at least a sub-set of the set of NF entities and a data collection policy indicating how the data shall be collected. An example of Step S410 is Step S640 shown in FIG. 6 which will be described in detail below.

Thereafter, in Step S420, selected data is determined based on the data collection object included in the data collection request, and then in Step S430, the selected data is collected based on the data collection policy included in the data collection request. An example of Step S420 and Step S430 is Step S650 shown in FIG. 6. The collected data is returned to the requesting NF entity in Step S440. An example of Step S440 is Step S670 shown in FIG. 6.

Some generic terms are used herein for brevity, and their meanings are explained below. It shall be understood by the skilled in the art that the terms may be changed in terminology, but the changed terminologies are included within and applicable in the present disclosure.

Analytics objects in the present disclosure means that a certain network operation can be improved by taking analytic actions based on the insight and context info received, such as:
Overload protection
Scale in/out of NF
Healing of NF, Network
Optimize configuration of NF, Network
Change QoS
Selection of Slice
Selection of NF

For example, the analytics object may comprise or indicate one or more of the above parameters mentioned in the bullets above, e.g. comprising or indicating an overload protection parameter, or a scale in/out of NF parameter etc.

Data collection Object in the present disclosure indicates data to be collected. In an embodiment of the present disclosure, the data collection object comprises at least one of a level of data collection; or a data object to be collected. For example, the data collection object may define a certain level NF data to be collected, i.e., categorized or grouped or filtered, such as:
Aggregated NF capacity; or
Aggregated NF load status.

As another example, the data collection object may define a specific data object to be collected, e.g., one or more items in the NF profiles, such as:
NF service name; or
the location of the NF(s).

Data collection policy in the present disclosure indicates how the data (determined by the data collection object) shall be collected. In an embodiment of the present disclosure, data collection policy comprises at least one of a type to which the data shall be collected belongs; or a temporal characteristics of data to be collected. For example, the data collection policy may define a specific type of data to be collected, such as:
a certain NF type (e.g., SMF) or NF types;
a certain slice or slices; or
a certain subscribe group.

As another example, the data collection policy may define specific temporal characteristics of data to be collected, such as:
a real time data collection;
a historical data collection; or
a streaming data collection.

As again another example, the data collection policy may define other characteristics of the data to be collected, such as:
data collection for NFs under/above certain capacity/load threshold; or
data collection for NFs at a specific location.

In an embodiment of the present disclosure, the data collection object and the data collection policy each may include more than one item. For example, the data collection policy may indicate a specific NF type in a certain slice, or a certain NF type for a certain subscribe group.

As an example, by combining the data collection object and the data collection policy, the data collection request maybe:
Aggregated NF capacity for a certain NF type in a certain slice; or
Aggregated NF load status for a certain NF type for a subscribe group.

Returning back to FIG. 4, in an embodiment of the present disclosure, Step S430 may further comprise Step S4330 of collecting data from those previously obtained from the sub-set of NF entities. For example, if the data collection request indicates it desires to collect history NF capacity for a certain NF type, for example, NF capacity for a certain NF type in the last week, last day or in the nearest five hours, and the NF entity that receives the data collection request, for example an NRF entity, has obtained NF profiles from NF entities served by the NRF entity. The NRF entity then may collect data from the obtained NF profiles.

In another embodiment, Step S430 may further comprise Step S4310 of determining, according to the data collection policy, whether it needs to obtain data from at least one NF entity of the sub-set of the set of NF entities, and Step S4320 of obtaining data from the at least one NF entity of the sub-set of the set of NF entities in response to determining that it needs to obtain updated data from the at least one NF entity in Step S4310. For example, if the data collection request indicates it desires to collect a streaming or a real time NF capacity for a certain NF type. The NF entity that receives the data collection request, for example an NRF entity, determines that updated or streaming NF profiles are needed, and then triggers an NRF management service to obtain NF profiles from NF entities served by the NRF entity. As another example, the NF entity that receives the data collection request is an NWDAF entity, which NWDAF entity determines that it desires to collect information on NF capacity for a certain NF type. The NWDAF entity may then forward the data collection request to a specific NRF entity to obtain the desired data from the NRF. That is, the NF entity that receives the data collection request may obtain desired data from another NF entity by some services if it does not have the data already.

In another embodiment, Step S420 may further comprise Step S4210 of parsing the data collection object to determine a data object to be collected that is directly obtainable from the selected data. For example, the data collection object indicates that an aggregated NF load status is to be collected. The receiving NF entity, for example, an NRF, may then parse the data collection object into a data object that is directly included in the NF profile, i.e., the load information at the NF, and then determine that the data to be collected is the load information. As another example, the data collection object indicates that a capacity of a serving node is to be collected. The NRF may then parse the data collection object to determine that the serving node includes NF 1, NF 2 and . . . NF n. The NRF entity then determines that the data to be collected is the capacity of NF1, NF 2, . . . NF n.

In an embodiment of the present disclosure, the data collection request comprises at least one data collection object and a least one data collection policy that corresponds to respective one of the at least one data collection object. For example, the data collection request may include two or more items of data collection objects, and each data collection object has a corresponding data collection policy. As an example, the data collection request may define that it desires an aggregated NF capacity for a first NF type and also an aggregated NF load status for a second NF type.

In an embodiment of the present disclosure, the data collection request further includes a return policy indicating how the data shall be returned. The return policy may be implicitly indicated by or included in the data collection object or the data collection policy. For example, the data collection policy may indicate that a streaming or real time data is needed. In such a case, the collected data shall be streaming returned or returned in real time. The return policy is thus implicitly indicated by the data collection policy and thus may be omitted in the data collection request. As another example, the data collection object may indicate that an aggregated NF capacity is needed. In such a case, the collected data shall be an aggregation of NF capacities in NF profiles. The return policy is thus implicitly indicated by the data collection object and thus may be omitted in the data collection request. In the case, the NF entity that receives the data collection request shall aggregate the obtained NF capacities and return the aggregated result.

In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. In such a case, the method 400 further comprises, prior to Step S440 of returning, Step S4410 of determining a form in which the data shall be returned according to the return policy; and processing the collected data to generate data in the determined form.

As another example, the return policy defines that the collected data shall be returned periodically, at a specific timing, or at that time the data collection request is received. The method 400 may then further comprise Step 440 of returning the collected data to the requesting NF entity at a timing defined according to the return policy. For example, the data collection request defines that it needs data of the last day, and the return policy defines that the data shall be returned at 5:00 am at the next day. The NF entity that receives the data collection request then collects the historical data and returns it at 5:00 pm at the date.

In an embodiment of the present disclosure, the requesting NF entity, i.e., the originator of the data collection request, may be at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF entity. The NRF entity may then generate a data collection request for the second NRF entity and obtain desired data from the second NRF entity. As still another example, an NSSF entity may need data to assist its network slice selection decision. The NSSF entity may then generate a data collection request indicating the data it needs, the data collection request being destined for a specific NRF entity. The NSSF entity may transmit the data collection request to an NWDAF entity, which NWDAF entity analyzes the data collection request and forward the data collection request to the specific NRF entity and data are returned therefrom. The NWDAF entity may then process the returned data, and deliver processed data to the NSSF entity.

FIG. 5 illustratively shows a flowchart of a method 500 for collecting data in a network comprising a set of NF entities according to an exemplary embodiment of the present disclosure. In an embodiment, the method 500 may be performed at a Network Data Analytics Function (NWDAF) entity.

As shown in FIG. 5, the method 500 may include Step S540 of transmitting a data collection request destined for a requested NF entity, including at least a data collection object indicating data to be collected from at least a sub-set of the set of NF entities and a data collection policy indicating how the data shall be collected; and Step S550 of receiving data from the requested NF entity in response to the transmission of the data collection request. An example of Step S540 is Step S640 shown in FIG. 6. An example of Step S550 is Step S670 shown in FIG. 6.

In an embodiment of the present disclosure, an NF entity in the network may need data of other entities in the network. It generates such a data collection request according to its demand, and transmits the generated data collection request to an NF entity, i.e., a requested NF entity, to receive the desired data from the requested NF entity.

In an embodiment of the present disclosure, the method 500 may comprise Step S510 of determining an analytics object; and Step S520 of generating the data collection object and the data collection policy based on the analytics object. In an embodiment of the present disclosure, the requesting NF entity, i.e., the originator of the data collection request, may be at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF entity. The NRF entity may then generate a data collection request for the second NRF entity and obtain desired data from the second NRF entity. As still another example, an NSSF entity may need data to assist its network slice selection decision. The NSSF entity may then generate a data collection request indicating the data it needs, the data collection request being destined for a specific NRF entity. The NSSF entity may transmit the data collection request to an NWDAF entity, which NWDAF entity analyzes the data collection request and forward the data collection request to the specific NRF and data are returned therefrom. The NWDAF entity may then process the returned data, and deliver processed data to the NSSF entity.

In an embodiment of the present disclosure, the method 500 may further comprise Step S530 of determining an NF entity to which the data collection request is transmitted according to the analytics object; and Step S540 of transmitting the data collection request to the determined NF entity. For example, an NWDAF entity that generates a data collection request may determine whether a data collection request destined for a specific NRF shall be delivered via an NEF. If it is determined that the data collection request shall be delivered via an NEF, it forwards the data collection request to the NEF, which NEF forwards the data collection request to the destined NRF. In another example, an NWDAF entity determines that data shall be collected from a specific NRF entity, or from a plurality of NRF entities. The NWDAF entity may then transmit the data collection request to the determined specific NRF entity or plurality of NRF entities.

In an embodiment of the present disclosure, the data collection request further includes a return policy indicating how the data shall be returned. In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. By indicating the form in the data collection request, the requestor may receive data in its desired form.

FIG. 6 shows an exemplifying signaling diagram 600 illustrating details of the methods schematically illustrated in FIGS. 4 and 5.

The example shown in FIG. 6 involves an NWDAF entity 601, an NEF entity 602, an NRF entity 603 and a set of NF entities, which are collectively denoted by a symbol 604. Some other NF entities, such as an NF entity 605, a PCF entity 606, an NSSF entity 607 and also an O&M entity 608, which may require data from other entities, are also shown in FIG. 6.

NF profiles of the set of NF entities 604 are updated/refreshed (S610) periodically to the NRF 603 which serves the set of NF entities 604, via NRF management procedures, e.g. registration/de-registraion/update/status probe etc., to make sure NRF can always have a proper information to serve for NF and NF service discovery in 3GPP 5GC.

One of the NF entity 605, PCF entity 606, NSSF entity 607 and O&M entity 608, e.g., the NSSF entity 607 needs some information, e.g. to assist its network slice selection decision, and it will generate a request to indicate its data collection requirement and transmit the data collection request to the NWDAF entity 601 (S620). In an example, the request may comprise a data analytics object. The NWDAF entity 601, upon receiving the data collection request, may generate an analytics object to obtain data for the NSSF entity 607 (S630). The NWDAF entity 601 then generates a data collection request based on the analytics object, including at least a data collection object and a data collection policy. The NWDAF entity 601 also makes a decision whether to use an NEF entity as an intermediate node to its target NRF. The NWDAF entity 601 transmits the data collection request to the NRF entity 603 (S640), potentially via the NEF 602. In an embodiment of the present disclosure, the analytics object is triggered locally or received from an external NF entity. For example, the analytics object may be triggered by the data collection request from the NSSF entity, triggered by internal configuration, or triggered by a command from another entity.

The NRF entity 603, upon receiving the data collection request, groups and categorizes the NF profiles it had received from the set of NF entities 604 (S650). As per definition, NF profiles compose of attributes/values that could be common for a plurality of NFs (e.g. NF types, location, slice, user group) or distinct per NF (e.g. IP address, Capacity, Load, health). The NRF entity 603 may make data collection based on the NF profile attributes, e.g. grouped by NF types, slice, location, user group etc., to make up a data view for a target group, showing their aggregated NF characteristics, e.g. aggregated Capacity per slice, aggregated Load status per NF type etc., as required by the data collection request.

In an example, the NRF entity 603 may need updated/freshed data from the set of NF entities 604, e.g., in a case that the data collection request indicates data to be collected is real time or streaming data. The NRF entity 603 may obtain updated/freshed NF profiles from the set of NF entities 604 via NRF management procedures (S660).

The NRF entity 603 then transits the collected data back to the NWDAF entity 601, potentially via the NEF entity 602 (S670). Upon receiving the collected data, the NWDAF entity 601 may perform an appropriate analytics operation on the data, to extract the data desired by the NSSF entity (S680). NWDAF entity 601 may also analyses the received data, together with other data received from other sources, performs analytics operations with a proper analytic method, e.g., analytics and machine intelligence engine, and generates a smart rule to trigger other NF entities to act.

The NWDAF entity 601 then transits the desired data to the NSSF entity 607 via, such as an NWDAF analytics service (S690). The NSSF entity 607 finally can make its slice section decision based on the data.

It should be understood that although FIG. 6 shows particular entities, such as NWDAF entity 601, NEF entity 602, NRF entity 603, PCF entity 606, NSSF entity 607 and O&M entity 608 as examples, they are not intended to be limiting of the exemplary embodiments in any way. Instead, the exemplary data collection procedure as shown in FIG. 6 may be implemented by other network entities as appropriate, if necessary.

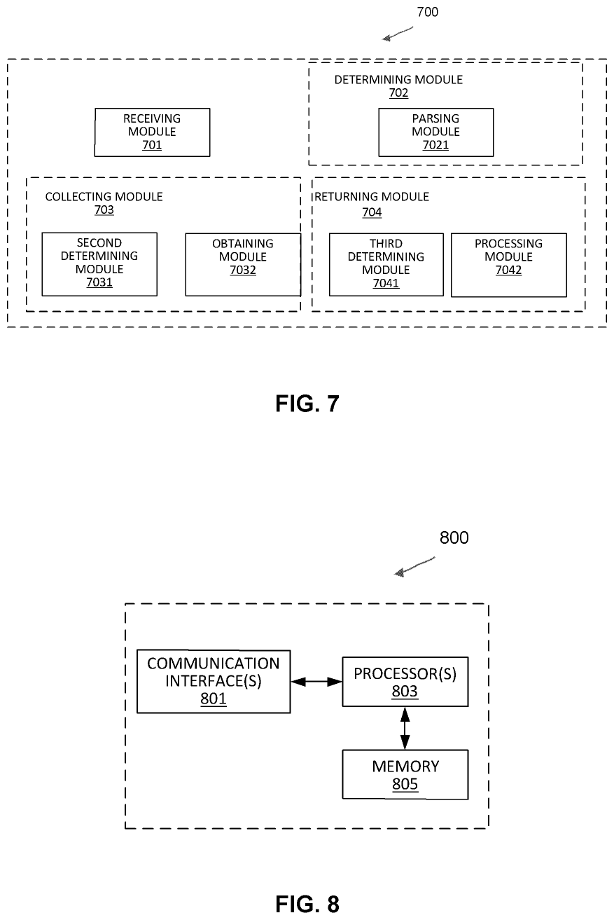

Hereinafter, a structure of an NF entity will be described with reference to FIG. 7. FIG. 7 illustratively shows a schematic structure diagram of an NF entity 700 (e.g. NRF 603 as shown in Figure, as described previously) according to an exemplary embodiment of the present disclosure. The NF entity 700 in FIG. 7 may perform the method 400 for data collection described previously with reference to FIG. 4. Accordingly, some detailed description on the NF entity 700 may refer to the corresponding description of the method 400 for data collection as previously discussed.

As shown in FIG. 7, the NF entity 700 may include a receiving module 701, a determining module 702, a collecting module 703 and a returning module 704. As will be understood by the skilled in the art, common components in the NF entity 700 are omitted in FIG. 7 for not obscuring the idea of the present disclosure. Also, some modules may be distributed in more modules or integrated into fewer modules. For example, the receiving module 701 and the returning module 704 may be integrated into a transceiver module.

The receiving module 701 of the NF entity 700 may be configured to receive a data collection request from a requesting NF entity, including at least a data collection object indicating data to be collected from at least a sub-set of the set of NF entities and a data collection policy indicating how the data shall be collected.

The determining module 702 of the NF entity 700 may be configured to determine selected data based on the data collection object included in the data collection request. The determining module 702 may be configured to include a parsing module 7021 which is configured to parse the data collection object to determine a data object to be collected that is directly obtainable from the selected data. For example, the data collection object indicates that an aggregated NF load status is to be collected. The parsing module 7021 may then parses the data collection object into a data object that is directly included in the NF profile, i.e., the load information at the NF, and then the determining module 702 determines that the data to be collected is the load information.

The collecting module 703 of the NF entity 700 may be configured to collect the selected data based on the data collection policy included in the data collection request.

In an embodiment of the present disclosure, the collecting module 703 may be configured to collect data from those previously obtained from the sub-set of NF entities. For example, if the data collection request indicates it desires to collect history NF capacity for a certain NF type, for example, NF capacity for a certain NF type in the last week, last day or in the nearest five hours, and the NF entity that receives the data collection request, for example an NRF entity, has obtained NF profiles from NF entities served by the NRF entity. The NRF entity then may collect data from the obtained NF profiles.

In another embodiment, the collecting module 703 may be configured to include a (second) determining module 7031 which is configured to determine, according to the data collection policy, whether it needs to obtain data from at least one NF entity of the sub-set of the set of NF entities, and an obtaining module 7032 which is configured to obtain data from the at least one NF entity of the sub-set of the set of NF entities in response to determining that it needs to obtain updated data from the at least one NF entity in determining module 7031. For example, if the data collection request indicates it desires to collect a streaming or a real time NF capacity for a certain NF type. The NF entity that receives the data collection request, for example an NRF entity, determines that updated or streaming NF profiles are needed, and then triggers an NRF management service to obtain NF profiles from NF entities served by the NRF entity. As another example, the NF entity that receives the data collection request is an NWDAF entity, which NWDAF entity determines that it desires to collect information on NF capacity for a certain NF type. The NWDAF entity may then forward the data collection request to a specific NRF entity to obtain the desired data from the NRF. That is, the NF entity that receives the data collection request may obtain desired data from another NF entity by some services if it does not have the data already.

In an embodiment of the present disclosure, the data collection request comprises at least one data collection object and a least one data collection policy that corresponds to respective one of the at least one data collection object. For example, the data collection request may include two or more items of data collection objects, and each data collection object has a corresponding data collection policy. As an example, the data collection request may define that it desires an aggregated NF capacity for a first NF type and also an aggregated NF load status for a second NF type.

The returning module 704 of the NF entity 700 may be configured to return the collected data to the requesting NF entity.

In an embodiment of the present disclosure, the data collection request further includes a return policy indicating how the data shall be returned. The return policy may be implicitly indicated by or included in the data collection object or the data collection policy. For example, the data collection policy may indicate that a streaming or real time data is needed. In such a case, the collected data shall be streaming returned or returned in real time. The return policy is thus implicitly indicated by the data collection policy and thus may be omitted in the data collection request. As another example, the data collection object may indicate that an aggregated NF capacity is needed. In such a case, the collected data shall be an aggregation of NF capacities in NF profiles. The return policy is thus implicitly indicated by the data collection object and thus may be omitted in the data collection request. In the case, the NF entity that receives the data collection request shall aggregate the obtained NF capacities and return the aggregated result.

In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. In such a case, the returning module 704 may be configured to include a (third) determining module 7041 which is configured to determine a form in which the data shall be returned according to the return policy, and a processing module 7042 which is configured to process the collected data to generate data in the determined form.

As another example, the return policy defines that the collected data shall be returned periodically, at a specific timing, or at that time the data collection request is received. In such a case, the returning module 704 may be configured to return the collected data to the requesting NF entity at a timing defined according to the return policy. For example, the data collection request defines that it needs data of the last day, and the return policy defines that the data shall be returned at 5:00 am at the next day. The NF entity that receives the data collection request then collects the historical data and returns it at 5:00 pm at the date.

In an embodiment of the present disclosure, the requesting NF entity, i.e., the originator of the data collection request, may be at least one of an NRF entity, an NWDAF entity, an NEF entity, an NSSF entity, an O&M entity, or a PCF entity. In an embodiment of the present disclosure, the requested NF entity, i.e., the NF entity 700, may be also at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF entity. The NRF entity may then generate a data collection request for the second NRF entity and obtain desired data from the second NRF entity. As still another example, an NSSF entity may need data to assist its network slice selection decision. The NSSF entity may then generate a data collection request indicating the data it needs, the data collection request being destined for a specific NRF entity. The NSSF entity may transmit the data collection request to an NWDAF entity, which NWDAF entity analyzes the data collection request and forward the data collection request to the specific NRF entity and data are returned therefrom. The NWDAF entity may then process the returned data, and deliver processed data to the NSSF entity.

Hereinafter, another structure of an NF entity 800 will be described with reference to FIG. 8. FIG. 8 illustratively shows a schematic structure diagram of an NF entity 800 (e.g., NRF 603 as shown in FIG. 6, as described previously) according to an exemplary embodiment of the present disclosure. The NF entity 800 in FIG. 8 may perform the method 400 for data collection described previously with reference to FIG. 4. Accordingly, some detailed description on the NF entity 800 may refer to the corresponding description of the method 400 for data collection as previously discussed.

As shown in FIG. 8, the NF entity 800 may include at least one controller or processor 803 including e.g., any suitable Central Processing Unit, CPU, microcontroller, Digital Signal Processor, DSP, etc., capable of executing computer program instructions. The computer program instructions may be stored in a memory 805. The memory 805 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary NF entity 800 further comprises a communication interface 801 arranged for communication.

The instructions, when loaded from the memory 805 and executed by the at least one processor 803, may cause the NF entity 800 to perform the method 400 as previously described.

In particular, the instructions, when loaded from the memory 805 and executed by the at least one processor 803, may cause the NF entity 800 to receive a data collection request from a requesting NF entity, including at least a data collection object indicating data to be collected from at least a sub-set of a set of NF entities and a data collection policy indicating how the data shall be collected. In an embodiment of the present disclosure, the data collection policy comprises at least one of a type to which the data shall be collected belongs; or a temporal characteristic of data to be collected. In another embodiment, the data collection object comprises at least one of a level of data collection; or a data object to be collected. In still another embodiment, the data collection request comprises at least one data collection object and a least one data collection policy that corresponds to respective one of the at least one data collection object. For example, the data collection request may include two or more items of data collection objects, and each data collection object has a corresponding data collection policy. As an example, the data collection request may define that it desires an aggregated NF capacity for a first NF type and also an aggregated NF load status for a second NF type.

The instructions, when loaded from the memory 805 and executed by the at least one processor 803, may cause the NF entity 800 to determine selected data based on the data collection object included in the data collection request, collect the selected data based on the data collection policy included in the data collection request, and return the collected data to the requesting NF entity.

In an embodiment of the present disclosure, the instructions, when loaded from the memory 805 and executed by the at least one processor 803, may further cause the NF entity 800 to collect data from those previously obtained from the sub-set of NF entities. For example, if the data collection request indicates it desires to collect history NF capacity for a certain NF type, for example, NF capacity for a certain NF type in the last week, last day or in the nearest five hours, and the NF entity that receives the data collection request, for example an NRF entity, has obtained NF profiles from NF entities served by the NRF entity. The NRF entity then may collect data from the obtained NF profiles.

In another embodiment, the instructions, when loaded from the memory 805 and executed by the at least one processor 803, may further cause the NF entity 800 to determine, according to the data collection policy, whether it needs to obtain data from at least one NF entity of the sub-set of the set of NF entities, and to obtain data from the at least one NF entity of the sub-set of the set of NF entities in response to determining that it needs to obtain updated data from the at least one NF entity. For example, if the data collection request indicates it desires to collect a streaming or a real time NF capacity for a certain NF type. The NF entity that receives the data collection request, for example an NRF entity, determines that updated or streaming NF profiles are needed, and then triggers an NRF management service to obtain NF profiles from NF entities served by the NRF entity. As another example, the NF entity that receives the data collection request is an NWDAF entity, which NWDAF entity determines that it desires to collect information on NF capacity for a certain NF type. The NWDAF entity may then forward the data collection request to a specific NRF entity to obtain the desired data from the NRF. That is, the NF entity that receives the data collection request may obtain desired data from another NF entity by some services if it does not have the data already.

In another embodiment, the instructions, when loaded from the memory 805 and executed by the at least one processor 803, may further cause the NF entity 800 to parse the data collection object to determine a data object to be collected that is directly obtainable from the selected data. For example, the data collection object indicates that an aggregated NF load status is to be collected. The receiving NF entity, for example, an NRF, may then parse the data collection object into a data object that is directly included in the NF profile, i.e., the load information at the NF, and then determine that the data to be collected is the load information. As another example, the data collection object indicates that a capacity of a serving node is to be collected. The NRF may then parse the data collection object to determine that the serving node includes NF 1, NF 2 and . . . NF n. The NRF entity then determines that the data to be collected is the capacity of NF1, NF 2, . . . NF n.

In an embodiment of the present disclosure, the data collection request further includes a return policy indicating how the data shall be returned. The return policy may be implicitly indicated by or included in the data collection object or the data collection policy. For example, the data collection policy may indicate that a streaming or real time data is needed. In such a case, the collected data shall be streaming returned or returned in real time. The return policy is thus implicitly indicated by the data collection policy and thus may be omitted in the data collection request. As another example, the data collection object may indicate that an aggregated NF capacity is needed. In such a case, the collected data shall be an aggregation of NF capacities in NF profiles. The return policy is thus implicitly indicated by the data collection object and thus may be omitted in the data collection request. In the case, the NF entity that receives the data collection request shall aggregate the obtained NF capacities and return the aggregated result.

In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. In such a case, the instructions, when loaded from the memory 805 and executed by the at least one processor 803, may further cause the NF entity 800 to determine a form in which the data shall be returned according to the return policy; and process the collected data to generate data in the determined form.

As another example, the return policy defines that the collected data shall be returned periodically, at a specific timing, or at that time the data collection request is received. The instructions, when loaded from the memory 805 and executed by the at least one processor 803, may further cause the NF entity 800 to return the collected data to the requesting NF entity at a timing defined according to the return policy. For example, the data collection request defines that it needs data of the last day, and the return policy defines that the data shall be returned at 5:00 am at the next day. The NF entity that receives the data collection request then collects the historical data and returns it at 5:00 pm at the date.

In an embodiment of the present disclosure, the requesting NF entity, i.e., the originator of the data collection request, may be at least one of an NRF entity, an NWDAF entity, an NEF entity, an NSSF entity, an O&M entity, or a PCF entity. In an embodiment of the present disclosure, the requested NF entity, i.e., the NF entity 800, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF entity. The NRF entity may then generate a data collection request for the second NRF and obtain desired data from the second NRF entity. As still another example, an NSSF entity may need data to assist its network slice selection decision. The NSSF entity may then generate a data collection request indicating the data it needs, the data collection request being destined for a specific NRF entity. The NSSF entity may transmit the data collection request to an NWDAF entity, which NWDAF entity analyzes the data collection request and forward the data collection request to the specific NRF and data are returned therefrom. The NWDAF entity may then process the returned data, and deliver processed data to the NSSF entity.

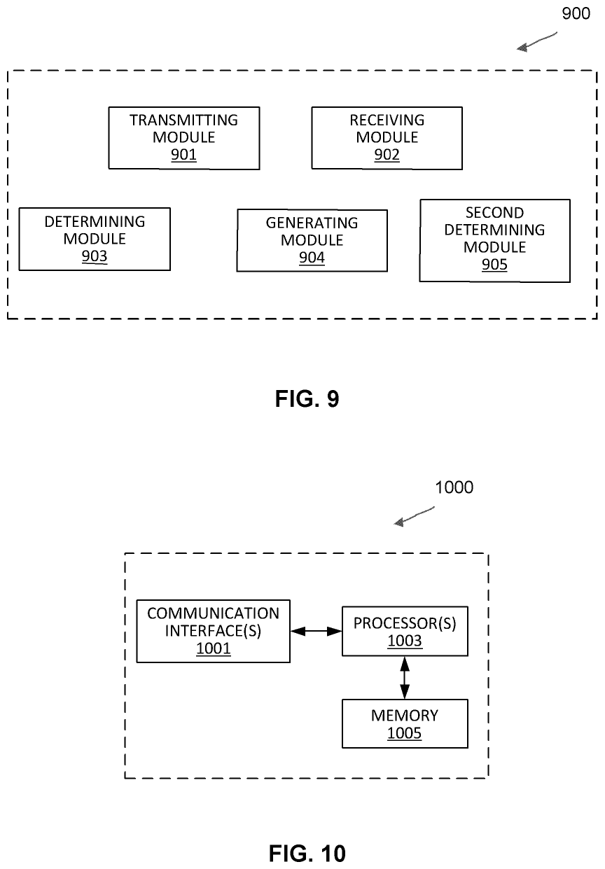

Hereinafter, a structure of an NF exposure entity will be described with reference to FIG. 9. FIG. 9 illustratively shows a schematic structure diagram of an NF entity 900 (e.g. NWDAF 601 as shown in FIG. 6, as described previously) according to an exemplary embodiment of the present disclosure. The NF entity 900 in FIG. 9 may perform the method 500 for data collection described previously with reference to FIG. 5. Accordingly, some detailed description on the NF entity 900 may refer to the corresponding description of the method 500 as previously discussed.

As shown in FIG. 9, the NF entity 900 may include a transmitting module 901 and a receiving module 902. As will be understood by the skilled in the art, common components in the NF entity 900 are omitted in FIG. 9 for not obscuring the idea of the present disclosure. Also, some modules may be distributed in more modules or integrated into fewer modules. For example, the transmitting module 901 and the receiving module 902 may be integrated into a transceiver module.

The transmitting module 901 of the NF entity 900 may be configured to transmit a data collection request destined for a requested NF entity, including at least a data collection object indicating data to be collected from at least a sub-set of the set of NF entities and a data collection policy indicating how the data shall be collected.

The receiving module 902 of the NF entity 900 may be configured to receive data from the requested NF entity in response to the transmission of the data collection request.

In an embodiment of the present disclosure, when the NF entity 900 needs data of other entities in the network, it generates such a data collection request according to its demand, and transmits the generated data collection request to an NF entity, i.e., a requested NF entity, to receive the desired data from the requested NF entity.

In an embodiment of the present disclosure, the NF entity 900 may further comprise a determining module 903 which is configured to determine an analytics object, and a generating module 904 which is configured to generate the data collection object and the data collection policy based on the analytics object.

In an embodiment of the present disclosure, the requesting NF entity, i.e., the NF entity 900 may be at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF entity. The NRF entity may then generate a data collection request for the second NRF entity and obtain desired data from the second NRF entity. As still another example, an NSSF entity may need data to assist its network slice selection decision. The NSSF entity may then generate a data collection request indicating the data it needs, the data collection request being destined for a specific NRF entity. The NSSF entity may transmit the data collection request to an NWDAF entity, which NWDAF entity analyzes the data collection request and forward the data collection request to the specific NRF entity and data are returned therefrom. The NWDAF entity may then process the returned data, and deliver processed data to the NSSF entity.

In an embodiment of the present disclosure, the NF entity 900 may further comprise a (second) determining module 905 which is configured to determine an NF entity to which the data collection request is transmitted according to the analytics object, and the transmitting module 901 is configured to transmit the data collection request to the determined NF entity. For example, an NWDAF entity that generates a data collection request may determine whether a data collection request destined for a specific NRF shall be delivered via an NEF. If it is determined that the data collection request shall be delivered via an NEF, it forwards the data collection request to the NEF, which NEF forwards the data collection request to the destined NRF. In another example, an NWDAF entity determines that data shall be collected from a specific NRF entity, or from a plurality of NRF entities. The NWDAF entity may then transmit the data collection request to the determined specific NRF entity or plurality of NRF entities.

In an embodiment of the present disclosure, the data collection request further includes a return policy indicating how the data shall be returned. In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. By indicating the form in the data collection request, the requestor may receive data in its desired form.

Hereinafter, another structure of an NF entity will be described with reference to FIG. 10. FIG. 10 illustratively shows a schematic structure diagram of an NF entity 1000 (e.g., NWDAF 601 as shown in FIG. 6, as described previously) according to an exemplary embodiment of the present disclosure. The NF entity 1000 in FIG. 10 may perform the method 500 for data collection described previously with reference to FIG. 5. Accordingly, some detailed description on the NF entity 1000 may refer to the corresponding description of the method 500 for data collection as previously discussed.

As shown in FIG. 10, the NF entity 1000 may include at least one controller or processor 1003 including e.g., any suitable Central Processing Unit, CPU, microcontroller, Digital Signal Processor, DSP, etc., capable of executing computer program instructions. The computer program instructions may be stored in a memory 1005. The memory 1005 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary NF entity 1000 further comprises a communication interface 1001 arranged for communication.

The instructions, when loaded from the memory 1005 and executed by the at least one processor 1003, may cause the NF entity 1000 to perform the method 500 as previously described.

In particular, the instructions, when loaded from the memory 1005 and executed by the at least one processor 1003, may cause the NF entity 1000 to transmit a data collection request destined for a requested NF entity, including at least a data collection object indicating data to be collected from at least a sub-set of the set of NF entities and a data collection policy indicating how the data shall be collected, and receive data from the requested NF entity in response to the transmission of the data collection request.

In an embodiment of the present disclosure, when the NF entity 1000 needs data of other entities in the network, it generates such a data collection request according to its demand, and transmits the generated data collection request to an NF entity, i.e., a requested NF entity, to receive the desired data from the requested NF entity.

In an embodiment of the present disclosure, the instructions, when loaded from the memory 1005 and executed by the at least one processor 1003, may cause the NF entity 1000 to determine an analytics object; and generate the data collection object and the data collection policy based on the analytics object.

In an embodiment of the present disclosure, the requesting NF entity, i.e., the NF entity 1000, may be at least one of an NRF entity, an NWDAF entity, an NEF entity, an NSSF entity, an O&M entity, or a PCF entity. In an embodiment of the present disclosure, the requested NF entity, i.e., the destination of the data collection request which has or can obtain the data to be collected, may be also at least one of an NRF entity, an NWDAF entity, an NEF entity, an NSSF entity, an O&M entity, or a PCF entity. For example, an NWDAF entity generates an analytics object internal or in response to a request from an external entity, for example an O&M entity, and realizes that it needs data based on the generated analytics object. The NWDAF entity may then generate a data collection request for an NRF entity based on the analytics object and obtain desired data from the NRF entity. As another example, an NRF entity may receive a demand from an external entity for data of NF entities served by another, second NRF. The NRF may then generate a data collection request for the second NRF and obtain desired data from the second NRF entity. As still another example, an NSSF entity may need data to assist its network slice selection decision. The NSSF entity may then generate a data collection request indicating the data it needs, the data collection request being destined for a specific NRF. The NSSF entity may transmit the data collection request to an NWDAF entity, which NWDAF entity analyzes the data collection request and forward the data collection request to the specific NRF entity and data are returned therefrom. The NWDAF entity may then process the returned data, and deliver processed data to the NSSF entity.

In an embodiment of the present disclosure, the instructions, when loaded from the memory 1005 and executed by the at least one processor 1003, may cause the NF entity 1000 to determine an NF entity to which the data collection request is transmitted according to the analytics object; and transmit the data collection request to the determined NF entity. For example, an NWDAF entity that generates a data collection request may determine whether a data collection request destined for a specific NRF shall be delivered via an NEF. If it is determined that the data collection request shall be delivered via an NEF, it forwards the data collection request to the NEF, which NEF forwards the data collection request to the destined NRF. In another example, an NWDAF entity determines that data shall be collected from a specific NRF entity, or from a plurality of NRF entities. The NWDAF entity may then transmit the data collection request to the determined specific NRF entity or plurality of NRF entities.

In an embodiment of the present disclosure, the data collection request further includes a return policy indicating how the data shall be returned. In an embodiment of the present disclosure, the return policy comprises at least one of a form in which the data shall be returned or a timing at which the data shall be returned. For example, the requestor that transmits the data collection request may need data in a specific data structure, which is not identical to that of the data stored/obtained at the NF that receives the data collection request. By indicating the form in the data collection request, the requestor may receive data in its desired form.

The foregoing description of implementations provides illustration and description, but is not intended to be exhaustive or to limit the disclosure to the precise form disclosed. Modifications and variations are possible in light of the above teachings, or may be acquired from practice of the disclosure.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1-35. (canceled)

36. A method for collecting data in a network comprising a set of Network Function (NF) entities, the method comprising:
receiving a data collection request from a requesting NF entity, the data collection request including at least a data collection object indicating data to be collected from at least a sub-set of the set of NF entities and a data collection policy indicating how the data shall be collected;
determining selected data based on the data collection object included in the data collection request;
collecting the selected data based on the data collection policy included in the data collection request; and
returning the collected data to the requesting NF entity.

37. The method of claim 36, wherein the collecting the selected data comprises:
determining, according to the data collection policy, whether the collector needs to obtain data from at least one NF entity of the sub-set of the set of NF entities; and
obtaining data from the at least one NF entity of the sub-set of the set of NF entities in response to determining that the collector needs to obtain updated data from the at least one NF entity.

38. The method of claim 36, wherein the determining selected data based on the data collection object included in the data collection request comprises parsing the data collection object to determine a data object to be collected that is directly obtainable from the selected data.

39. The method of claim 36, wherein the data collection request further includes a return policy indicating how the data shall be returned.

40. The method of claim 39, further comprising, prior to returning:
determining a form in which the data shall be returned according to the return policy; and
processing the collected data to generate data in the determined form.

41. The method of claim 39, wherein the returning the collected data to the requesting NF comprises returning the collected data to the requesting NF entity at a timing defined according to the return policy.

42. A method of collecting data in a network comprising a set of Network Function (NF) entities, the method comprising:
transmitting a data collection request destined for a requested NF entity, the data collection request including at least a data collection object indicating data to be collected from at least a sub-set of the set of NF entities and a data collection policy indicating how the data shall be collected; and
receiving data from the requested NF entity in response to the transmission of the data collection request.

43. The method of claim 42, further comprising:
determining an analytics object; and
generating the data collection object and the data collection policy based on the analytics object.

44. The method of claim 43, further comprising:
receiving the analytics object from an external NF entity, or triggering the analytics object locally;
determining an NF entity to which the data collection request is transmitted according to the analytics object; and
transmitting the data collection request to the determined NF entity.

45. The method of claim 42, wherein the data collection request further includes a return policy indicating how the data shall be returned.

46. A Network Function (NF) entity in a network comprising a set of Network Function (NF) entities, the NF entity comprising:
processing circuitry;
memory containing instructions executable by the processing circuitry whereby the NF entity is operative to:
receive a data collection request from a requesting NF entity, the data collection request including at least a data collection object indicating data to be collected from at least a sub-set of the set of NF entities and a data collection policy indicating how the data shall be collected;
determine selected data based on the data collection object included in the data collection request;
collect the selected data based on the data collection policy included in the data collection request; and
return the collected data to the requesting NF entity.

47. The NF entity of claim 46, wherein the instructions are such that the NF entity is operative to:
determine, according to the data collection policy, whether the NF entity needs to obtain data from at least one NF entity of the sub-set of the set of NF entities; and
obtain data from the at least one NF entity of the sub-set of the set of NF entities in response to determining that that the NF entity needs to obtain updated data from the at least one NF entity.

48. The NF entity of claim 46, wherein the instructions are such that the NF entity is operative to parse the data collection object to determine a data object to be collected that is directly obtainable from the selected data.

49. The NF entity of claim 46, wherein the data collection request further includes a return policy indicating how the data shall be returned.

50. The NF entity of claim 49, wherein the instructions are such that the NF entity is operative to:
determine a form in which the data shall be returned according to the return policy; and
process the collected data to generate data in the determined form.

51. The NF entity of claim 49, wherein the instructions are such that the NF entity is operative to return the collected data to the requesting NF entity at a timing defined according to the return policy.

52. A Network Function (NF) entity in a network comprising a set of Network Function (NF) entities, the NF entity comprising:
processing circuitry;
memory containing instructions executable by the processing circuitry whereby the NF entity is operative to:
transmit a data collection request destined for a requested NF entity, the data collection request including at least a data collection object indicating data to be collected from at least a sub-set of the set of NF entities and a data collection policy indicating how the data shall be collected; and
receive data from the requested NF entity in response to the transmission of the data collection request.

53. The NF entity of claim 52, wherein the instructions are such that the NF entity is operative to:
determine an analytics object; and
generate the data collection object and the data collection policy based on the analytics object.

54. The NF entity of claim 53, wherein the instructions are such that the NF entity is operative to:
trigger the analytics object locally or receive the analytics object from an external NF entity;
determine an NF entity to which the data collection request is transmitted according to the analytics object; and
transmit the data collection request to the determined NF entity.

55. The NF entity of claim 52, wherein the data collection request further includes a return policy indicating how the data shall be returned.
